(19) United States
(12) Patent Application Publication
(10) Pub. No.: US 2014/0267104 A1
(43) Pub. Date: Sep. 18, 2014

(54) OPTIMIZED ADAPTIVE THRESHOLDING FOR TOUCH SENSING

(71) Applicant: QUALCOMM Incorporated, San Diego, CA (US)

(72) Inventors: Mohamed Imtiaz AHMED, San Marcos, CA (US); William Y. Huang, Vista, CA (US); Suhail Jalil, Poway, CA (US); Raghukul Tilak, San Diego, CA (US); Khosro Mohammad Rabii, San Diego, CA (US)

(73) Assignee: QUALCOMM Incorporated, San Diego, CA (US)

(21) Appl. No.: 14/195,491

(22) Filed: Mar. 3, 2014

Related U.S. Application Data
(60) Provisional application No. 61/803,076, filed on Mar. 18, 2013.

(51) Int. Cl. G06F 3/041

(52) U.S. Cl. CPC G06F 3/041
USPC 345/173

(57) ABSTRACT

Methods, systems, computer-readable media, and apparatuses for recognizing touch input for a touch panel are presented. In some embodiments, a method for recognizing touch input for a touch panel includes scanning the touch panel over a first frame including at least one touch panel blob resulting from a touch on the touch panel. The method also includes scanning the touch panel over a second frame including at least one touch panel blob resulting from a touch on the touch panel. The method additionally includes processing the touch panel blob within the first frame based at least in part on a first touch-reporting sensitivity and processing the touch panel blob within the second frame based at least in part on a second touch-reporting sensitivity. The method further includes determining whether a valid touch exists based at least in part on the processing step.

This application claims the benefit of U.S. Provisional Application No. 61/803,076, filed Mar. 18, 2013, entitled “OPTIMIZED ADAPTIVE THRESHOLDING FOR TOUCH SENSING” which is incorporated herein by reference.

### BACKGROUND

Aspects of the disclosure relate to a touch device, and more particularly, to a comprehensive framework and techniques for touch sensing.

Devices such as computing devices, mobile devices, kiosks, etc. often employ a touch screen interface with which a user can interact with the devices by touch input (e.g., touch by a user or an input tool such as a pen). Touch screen devices employing the touch screen interface provide convenience to users, as the users can directly interact with the touch screen. The touch screen devices receive the touch input, and execute various operations based on the touch input. For example, a user may touch an icon displayed on the touch screen to execute a software application associated with the icon, or a user may draw on the touch screen to create drawings. The user may also drag and drop items on the touch screen or may pan a view on the touch screen with two fingers. Thus, a touch screen device that is capable of accurately analyzing the touch input on the touch screen is needed to accurately execute desired operations. Various factors such as noise may affect performance of the touch screen, and may affect accuracy of the operation of the touch screen device. In addition, touch sizes between various touch inputs (e.g., touch by a user or an input tool such as a pan) can vary greatly depending on the touch input used or the manner in which the touch is performed (e.g., finger flat on the touch screen interface vs. finger barely touching the touch screen interface). Existing touch screen interfaces are configured (or tuned) to detect a particular touch size (e.g., a finger touch), and as such, may reject touches from other touch inputs (e.g., input tool such as a pen or stylus) as noise rather than a valid touch.

Therefore, a touch screen device that can adaptively detect and process various touch sizes is desired in order to improve accuracy of the touch screen operations.

### BRIEF SUMMARY

Certain embodiments describe a system and method for improved touch input recognition on a touch panel interface.

Systems and methods disclosed herein allow for time multiplexing of touch input determination and processing on a touch screen interface. When scanning the touch panel of the touch screen interface, one or more frames can be dedicated for detecting a touch from a touch input that results in a first touch size (e.g., stylus) and one or more frames can be dedicated for detecting a touch from a touch input that results in a second touch size (e.g., user finger). The scan rate and sensitivity used to detect the touch can be adjusted for the frames dedicated to detecting a particular touch size. For example, the frames that are dedicated to detecting a touch from a stylus input can be processed with a high scan rate and high sensitivity. On the other hand, the frames that are dedicated to detecting a touch from a finger input can be processed with a medium scan rate and medium sensitivity.

In some embodiments, a method for recognizing touch input for a touch panel includes scanning the touch panel over a first frame including at least one touch panel blob resulting from a touch on the touch panel. The method also includes scanning the touch panel over a second frame including at least one touch panel blob resulting from a touch on the touch panel. The method additionally includes processing the touch panel blob within the first frame based at least in part on a first touch-reporting sensitivity and processing the touch panel blob within the second frame based at least in part on a second touch-reporting sensitivity. The method further includes determining whether a valid touch exists based at least in part on the processing step.

In some embodiments, the method includes scanning the touch panel over a third frame including at least one touch panel blob resulting from a touch on the touch panel, processing the touch panel blob within the third frame based at least in part on a third touch-reporting sensitivity, and determining whether a valid touch exists based at least in part on the processing step.

In some embodiments, processing the touch panel blob within the third frame comprises processing the touch panel blob with a false-touch rejection size of less than 2 millimeters and greater than 19 millimeters in diameter.

In some embodiments, the method includes determining a position of the touch panel blob relative to the touch panel based at least in part on the processing step.

In some embodiments, the processing step further comprises adjusting a scan rate of the touch panel.

In some embodiments, the processing step further comprises filtering and interpolating the touch panel blob.

In some embodiments, processing the touch panel blob within the first frame comprises processing the touch panel blob with a false-touch rejection size of less than 19 millimeters in diameter.

In some embodiments, processing the touch panel blob within the second frame comprises processing the touch panel blob with a false-touch rejection size of greater than 2 millimeters in diameter.

In some embodiments, an apparatus for recognizing touch input for a touch panel includes a touch panel, a memory comprising touch positioning logic, and a processor coupled to the touch panel and the memory. The processor is operable, when the touch positioning logic is executed, to scan the touch panel over a first frame including at least one touch panel blob resulting from a touch on the touch panel, scan the touch panel over a second frame including at least one touch panel blob resulting from a touch on the touch panel, process the touch panel blob within the first frame based at least in part on a first touch-reporting sensitivity and processing the touch panel blob within the second frame based at least in part on a second touch-reporting sensitivity, and determine whether a valid touch exists based at least in part on the processing step.

In some embodiments, an apparatus for recognizing touch input for a touch panel includes means for scanning the touch panel over a first frame including at least one touch panel blob resulting from a touch on the touch panel, means for scanning the touch panel over a second frame including at least one touch panel blob resulting from a touch on the touch panel, means for processing the touch panel blob within the first frame based at least in part on a first touch-reporting sensitivity and processing the touch panel blob within the second frame based at least in part on a second touch-reporting sensitivity, and means for determining whether a valid touch exists based at least in part on the processing step.

In some embodiments, a processor-readable non-transitory medium comprises processor readable instructions configured to cause a processor to scan a touch panel over a first frame including at least one touch panel blob resulting from a touch on the touch panel, scan the touch panel over a second frame including at least one touch panel blob resulting from a touch on the touch panel, process the touch panel blob within the first frame based at least in part on a first touch-reporting sensitivity and processing the touch panel blob within the second frame based at least in part on a second touch-reporting sensitivity, and determine whether a valid touch exists based at least in part on the processing step.

### BRIEF DESCRIPTION OF THE DRAWINGS

Aspects of the disclosure are illustrated by way of example. In the accompanying figures, like reference numbers indicate similar elements, and:

FIG. 1 illustrates a simplified block diagram of a portable device that may incorporate one or more embodiments;

FIG. 2A illustrates various unimanual touch gestures and corresponding touch primitives, according to some embodiments;

FIG. 2B illustrates various gestures involving a pen-touch and corresponding touch primitives, according to some embodiments;

FIG. 3 illustrates a gesture involving a pen-touch on a touch panel and the corresponding touch primitives, according to some embodiments;

FIG. 4 is a block diagram of an adaptive touch signal processing architecture, according to some embodiments;

FIG. 5 illustrates touch primitives (or touch blobs) within multiple frames captured by a touch interface;

FIG. 6 is a table 600 illustrating adaptation schemes for processing different types of touches;

FIG. 7 is a flowchart illustrating a method for touch-size dependent adaptive touch processing;

FIG. 8 is a flowchart illustrating an exemplary method for recognizing touch input for a touch panel;

FIG. 9 illustrates an example of a computing system in which one or more embodiments may be implemented;

FIG. 10 is a diagram illustrating an example of mobile device architecture with a touch screen display and an external display device;

FIG. 11 is a diagram illustrating an example of a mobile touch screen device with a touch screen controller;

FIG. 12 illustrates an example of a capacitive touch processing data path in a touch screen device;

FIG. 13 illustrates a closer look at display and touch subsystems in mobile-handset architecture;

FIG. 14 is a flow chart of a method of signal threshold determination; and

FIG. 15 is a flow chart of a method of signal threshold determination.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of touch screen devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Touch screen technology enables various types of uses. As discussed supra, a user may touch a touch screen to execute various operations such as execution of an application. In one example, the touch screen provides a user interface with a direct touch such as a virtual-keyboard and user-directed controls. The user interface with the touch screen may provide proximity detection. The user may hand-write on the touch screen. In another example, the touch screen technology may be used for security features, such as surveillance, intrusion detection and authentication, and may be used for a use-environment control such as a lighting control and an appliance control. In another example, the touch screen technology may be used for healthcare applications (e.g., a remote sensing environment, prognosis and diagnosis).

Several types of touch screen technology are available today, with different designs, resolutions, sizes, etc. Examples of the touch screen technology with lower resolution include acoustic pulse recognition (APR), dispersive signal technology (DST), surface acoustic wave (SAW), traditional infrared (IR/NIR), waveguide infrared, optical, and force-sensing. A typical mobile device includes a capacitive touch screen (e.g., mutual projective-capacitance touch screen), which allows for higher resolution and a thin size of the screen. Further, a capacitive touch screen provides good accuracy, good linearity and good response time, as well as relatively low chances of false negatives and false positives. Therefore, the capacitive touch screen is widely used in mobile devices such as mobile phones and tablets. Examples of a capacitive touch screen used in mobile devices include an in-cell touch screen and an on-cell touch screen, which are discussed infra.

### Portable Device Including a Capacitive Touch Panel

FIG. 1 illustrates a simplified block diagram of a portable device 100 that may incorporate one or more embodiments. Portable device 100 includes a processor 110, display 130, input device 140, speaker 150, memory 160, capacitive touch panel 170, digital touch interface 180, and computer-readable medium 190.

Processor 110 may be any general-purpose processor operable to carry out instructions on the portable device 100. The processor 110 is coupled to other units of the portable device 100 including display 130, input device 140, speaker 150, capacitive touch panel 170, digital touch interface 180, and computer-readable medium 190.

Display 130 may be any device that displays information to a user. Examples may include an LCD screen, CRT monitor, or seven-segment display.

Input device 140 may be any device that accepts input from a user. Examples may include a keyboard, keypad, mouse, or touch input.

Speaker 150 may be any device that outputs sound to a user. Examples may include a built-in speaker or any other device that produces sound in response to an electrical audio signal.

Memory 160 may be any magnetic, electronic, or optical memory. Memory 160 includes two memory modules, module 1 162 and module 2 164. It can be appreciated that memory 160 may include any number of memory modules. An example of memory 160 may be dynamic random access memory (DRAM).

The capacitive touch panel 170 and the display 130 may be generally coextensive and form a user interface for the device 100. A user may touch the capacitive touch panel 170 to control operation of the portable device 100. In some embodiments, the touch may be made by a single finger of the user or by several fingers. In other embodiments, the touch may be made by other portions of the user's hand or other body parts. In yet other embodiments, the touch may be made by the use of a stylus gripped by the user or otherwise brought into contact with the capacitive touch panel 170. The touches may be intentional or inadvertent on the part of the user. In other applications, the capacitive touch panel 170 may be embodied as a touch pad of the portable device 100. In such an application, the display 130 may not be coextensive with the capacitive touch panel 170 but may be located nearby for viewing by a user who touches the capacitive touch panel 170 to control the computing device.

Digital touch interface 180 can include a touch front end (TFE) and/or a touch back end (TBE). This partition is not fixed or rigid, but may vary according to the high-level function(s) that each block performs and that are assigned or considered front end or back end functions. The TFE operates to detect the capacitance of the capacitive sensor that comprises the capacitive touch panel 170 and to deliver a high signal to noise ratio (SNR) capacitive image (or heatmap) to the TBE. The TBE can take this capacitive heatmap from the TFE and discriminate, classify, locate, and track the object(s) touching the capacitive touch panel 170 and report this information back to the processor 110. The TFE and the TBE may be partitioned among hardware and software or firmware components as desired, e.g., according to any particular design requirements. In one embodiment, the TFE may be largely implemented in hardware components and some or all of the functionality of the TBE may be implemented by the processor 110.

Computer-readable medium 190 may be any magnetic, electronic, optical, or other computer-readable storage medium. Computer-readable medium 190 may include one or more software modules executable by processor 110.

### Touch Gestures and Touch Primitives

FIG. 2A illustrates various unimanual touch gestures and corresponding touch primitives. The various touch gestures may be performed by a user on a touch panel of a device having a touch interface. For example, the various touch gestures may be performed by a user on the capacitive touch panel 170 (FIG. 1). The various unimanual touch gestures can include gestures made using a finger 202 or an entire hand 204. Some gestures may be made performed by simply touching the finger 202 or hand 204 to the capacitive touch panel 170 (FIG. 1). Other gestures may be performed by performing a “swipe” motion with the finger 202 or hand 204 on the capacitive touch panel 170 (FIG. 1).

When the finger 202 or hand 204 comes into contact with the capacitive touch panel 170 (FIG. 1), the capacitive touch panel 170 (FIG. 1) may detect a touch primitive or touch “blob” resulting from the touch. The touch primitive or “blob” may be thought of as an imprint of the touch on the touch panel 170 (FIG. 1). In other words, the touch primitive or “blob” may be a set of signals representative of the sensed touch area on the capacitive touch panel 170 (FIG. 1). The touch primitives resulting from the touches may be different depending on the type of touch and size of the touch. For example, a touch from a finger 202 on the capacitive touch panel 170 (FIG. 1) may result in a first touch primitive 206. A touch from a hand 204 on the capacitive touch panel 170 (FIG. 1) may result in a second touch primitive 208. In some embodiments, the first touch primitive 206 can be smaller than the second touch primitive 208, since the resulting touch from the finger 202 is smaller than the resulting touch from the hand 204.

It can be appreciated that the size of the touch resulting from the finger 202 can vary. For example, typical touches that result from finger 202 touch can vary between 7 millimeters (mm) and 14 mm depending on the profile of the finger 202. At times, a finger may be laid flat on the capacitive touch panel 170 (FIG. 1), at other times the finger 202 may be pushed on the capacitive touch panel 170 (FIG. 1) with moderate pressure, or sometimes the finger 202 may be pushed on the capacitive touch panel 170 (FIG. 1) with light pressure. It can be appreciated that in each instance, the size of the touch primitive may vary. It can also be appreciated that these are just a few examples of types of touches that may be performed with a finger 202 and that various other types of touches resulting in various other sizes of touch primitives may be possible. For example, the size of the first touch primitive 206 may vary depending on the size of the finger 202 and the manner in which the finger 202 performed the touch gesture.

These concepts also extend to touches by the hand 204. That is, touches by the hand 204 on the capacitive touch panel 170 (FIG. 1) can result in various different sizes of touch primitives depending on the size of the hand 204 and the manner in which the hand 204 performed the touch gesture. For example, the size of the second touch primitive 208 may vary depending on the size of the hand 204 and the manner in which the hand 204 performed the touch gesture.

Often times the touch interface (capacitive touch panel) in a portable device described above is tuned or configured to detect valid touches based on touch primitive sizes between preconfigured sizes. For example, if the portable device is expected to be receive touch input from a user's finger 202, may be tuned or configured to determine touches to be valid if they have a touch primitive with a size between 7 mm and 14 mm. The touch interface may consider any touch primitives (that are a result of touches on the capacitive touch panel 170 (FIG. 1)) outside of this range as noise and may reject them as invalid touches or accidental touches. Similarly, if the portable device is expected to receive touch input from a user's hand 204, it may be tuned or configured to determine touches to be valid if they have a touch primitive greater than 19 mm. The touch interface may consider any touch primitives (that are a result of touches on the capacitive touch panel 170 (FIG. 1)) below this value as noise and reject them as invalid touches or accidental touches. As a result, the portable device may often times incorrectly reject a hand 204 touch by the user because the touch interface is tuned or configured to only detect finger 202 touches as valid touches, or vice versa.

A touch interface that can dynamically tune or configure sensing of various touches with different touch primitive sizes by time multiplexing the sensing and detection of the various touches is described in further detail below.

FIG. 2B illustrates various gestures involving a pen-touch and corresponding touch primitives. The various touch gestures may be performed by a user on a touch panel of a device having a touch interface. For example, the various touch gestures may be performed by a user on the capacitive touch panel 170 (FIG. 1). The various touch gestures can include gestures made using a pen input tool (e.g., a stylus 210). Some gestures may be made performed by simply touching the stylus 210 to the capacitive touch panel 170 (FIG. 1). Other gestures may be performed by performing a dragging motion with the stylus 210 on the capacitive touch panel 170 (FIG. 1).

When the stylus 210 comes into contact with the capacitive touch panel 170 (FIG. 1), the capacitive touch panel 170 (FIG. 1) may detect a touch primitive or “blob” resulting from the touch, as described above. The touch primitives resulting from the touches may be different depending on the type of touch and size of the touch. For example, a touch from the stylus 210 on the capacitive touch panel 170 (FIG. 1) may result in a stylus touch primitive 216. In the course of using the stylus 210, the user may also have parts of his/her hand in contact with the touch panel, such as when using the stylus 210 to write or draw in a natural fashion. For example, the user's palm 212 or fingers 214 may be in contact with (touching) the touch panel while the user is operating the stylus 210. A touch from the user's palm 212 or fingers 214 on the capacitive touch panel 170 (FIG. 1) may result in a palm touch primitive 218 and/or finger touch primitive 220, respectively. As described above, each of the touch primitives may be of a different size based on various factors.

It can be appreciated that the size of the touch resulting from the stylus 210 can vary. For example, typical touch primitives that result from the stylus 210 can be 2 mm or less. The size of the stylus touch primitive 216 resulting from the stylus 210 touch can also vary depending on the angle at which the user holds the stylus when using the stylus to interact with the touch panel. The size of the palm touch primitive 218 and finger touch primitive 220 may also vary depending on the manner in which the user places his/her palm 212 or finger 214 on the touch screen device.

Often times the touch interface in the device described above, with respect to FIG. 1, is tuned or configured to detect valid touches based on touch primitive sizes typical for a finger 214. For example, the touch interface may be tuned or configured to consider touch primitives between 7 mm and 14 mm as valid touches. The touch interface may consider any touch primitives (that are a result of touches on the capacitive touch panel 170 (FIG. 1)) outside of this range as noise and may reject them as invalid touches or accidental touches. As a result, the portable device may often times incorrectly reject a stylus 210 touch by the user because the touch interface is tuned or configured to only detect finger 202 touches as valid touches. That is, the user may not be able to interact with the touch interface using a stylus 210 because the touch interface is only tuned to sense and detect touch primitives for a finger 202 touch. The touches primitives resulting from the stylus 210 touch may be ignored by the touch interface as noise because the touch primitive size may be out of the range of an expected finger touch primitive 220.

A touch interface that can dynamically tune or configure sensing of various touches with different touch primitive sizes by time multiplexing the sensing and detection of the various touches is described in further detail below.

FIG. 3 illustrates a gesture involving a pen-touch on a touch panel and the corresponding touch primitives. The illustration in FIG. 3 shows a user's hand handling a stylus 210 device to interact with a capacitive touch panel 170 (FIG. 1). The illustration also shows the touch primitives described with respect to FIG. 2B. In the process of the user holding the stylus 210 in a natural writing position, the user's finger 214, palm 212, and the stylus 210 may touch the capacitive touch panel 170. As described above, as a result of touching the capacitive touch panel 170, one or more touch primitives may be detected by the touch interface. The touch primitives may include a stylus touch primitive 216, a palm touch primitive 218, and a finger touch primitive 220.

As described above, the touch interface may be tuned or configured to detect particular touch primitive sizes as valid touches and reject other touch primitive sizes as noise. For example, in FIG. 3, if the touch interface is tuned or configured to detect touch inputs from a finger 214, the touch interface may consider touch primitives resulting from a touch on the capacitive touch panel 170 between 7 mm and 14 mm as valid touches. Any touch primitives outside this range may be considered noise and rejected as invalid touches. As a result, the stylus touch primitive 216 resulting from a stylus 210 touch may be rejected as noise by the touch interface because stylus 210 touches typically result in touch primitives with sizes of 2 mm or less. That is, a touch interface tuned or configured for finger 214 touches may not be able to accurately detect a touch from a stylus 210.

In another example, the user may decide to no longer use the stylus 210 to interact with the touch interface and instead wishes to interact with the touch interface using his/her finger 214. However, if the touch interface is tuned or configured to detect touch inputs from a stylus 210, it may only consider touch primitives resulting from a touch on the capacitive touch panel 170 equal to or less than 2 mm as valid touches. Any touch primitives above this range may be considered noise and rejected as invalid touches. As a result, the finger touch primitive 220 or palm touch primitive 218 may be rejected by the touch interface as noise since both of these touch primitives are greater than 2 mm in size. In other words, a touch interface configured to detect touch input from a stylus 210, may not be able to accurately detect a touch from finger 214 or palm 212.

A touch interface that can dynamically tune or configure sensing of various touches with different touch primitive sizes by time multiplexing the sensing and detection of the various touches is described in further detail below.

### Adaptive Touch Interface

FIG. 4 is a block diagram of an adaptive touch signal processing architecture 400, according to some embodiments. The touch signal processing architecture 400 may dynamically tune or configure sensing of touches having various touch primitive sizes by time multiplexing the sensing and detection of the various touch primitive sizes.

The touch signal processing architecture 400 includes a kernel 410, touch libraries 430, a platform touchscreen subsystem 440, and a stylus signaling processor 460.

The platform touchscreen subsystem 440 includes a real-time raw touch-signal interface coupled to touch sub-system controls 453 and a protocol processing unit 442. The touch sub-system controls 453 is coupled to a touch activity & status detection unit 443, an active noise rejection unit 444, a touch reference estimation, and a baselining & adaptation unit 445. The protocol processing unit 442, the touch activity & status detection unit 443, and the active noise rejection unit 444 are also coupled to a correlated sampling unit 446. The correlated sampling unit 446 is coupled the touch reference estimation, baselining, and adaptation unit 445. The touch reference estimation, baselining and adaptation unit 445 is coupled to an analog front-end unit 447. The analog front-end unit 447 may communicate with the touch screen panel and interface 454 to receive an analog touch signal based on a user touch on the touch screen, and may convert the analog touch signal to a digital touch signal to create touch signal raw data. The analog front-end unit 447 may include row/column drivers and an analog-to-digital converter (ADC).

The platform touchscreen subsystem 440 also includes battery, charging-circuit and power manager unit 450. The battery, charging-circuit and power manager unit 450 may interface with another power subsystem of the portable device located outside of the touch signal processing architecture 400. In some embodiments, the power manager unit 449 may exist separately from the battery, charging-circuit and power manager unit 450. The power manager unit 449 may be coupled to a scanning engine 448. The scanning engine 448 is also coupled to the touch-subsystem controls 453. The platform touchscreen subsystem 440 also includes temperature compensated crystal oscillators (TCXOs), phase-lock loops (PLLs), and clock generators component 446. The TXCO, PLLs, and clock generators component 446 is coupled to clocks and timing circuitry 452. The TXCO, PLLs, and clock generators component 446 may communicate with other timing components of the portable device located outside of the touch signal processing architecture 400.

The kernel 410 includes a stylus driver 422 that is coupled to an external stylus signaling processor 460. The stylus signaling processor 460 may notify the stylus driver 422 of detection of a stylus within proximity of the portable device. The stylus driver 422 is coupled to touch interface driver 423. The touch interface driver 423 is also coupled to the real-time raw touch-signal protocol processing unit 413. The real-time raw touch-signal protocol processing unit 413 is coupled to the real-time raw touch-signal interface 441 within the platform touchscreen subsystem 440. The touch interface driver 423 receives interrupt requests from a touch-driver IRQ handler 411 and a kernel IRQ handler 412. The real-time raw touch-signal protocol processing unit 413 may communicate to the kernel IRQ handler 412 the presence of a user touch. The kernel IRQ handler 412 may communicate a trigger signal to the touch-driver IRQ handler 411 which may in turn communicate a trigger signal to the touch interface driver 423.

The real-time raw touch-signal protocol processing unit 413 is also coupled to the digital filtering unit 414. The digital filtering unit 414 is coupled to a Gaussian blur-subtraction unit 415. The Gaussian blur-subtraction unit 415 is coupled to a blob analysis unit 416. The blob analysis unit 416 is coupled to the false-touch rejection unit 417. The false-touch rejection unit 417 is coupled to the final touch filtering unit 418. The final touch filtering unit 418 is coupled to the fine-touch interpolation unit 419. The fine-touch interpolation unit 419 is coupled to the touch coordinate & size calculation unit 420. The touch coordinate & size calculation unit 420 is coupled to the OS input layer 421. The raw touch-signal protocol processing unit 413, digital filtering unit 414, Gaussian blur-subtraction unit 415, blob analysis unit 416, false-touch rejection unit 417, final touch filtering unit 418, fine-touch interpolation unit 419, and touch coordinate & size calculation unit 420 make up the raw-touch signal processor.

The touch libraries 430 include touch library & hardware abstraction layer 431, touch service library 432, and touch manager library 433. The touch library & hardware abstraction layer 431 is communicatively coupled to the OS input layer 421.

It can be appreciated that the scanning engine 448, analog front-end unit 447, touch reference estimation, baselining & adaptation unit 445, correlated sampling unit 446, false-touch rejection unit 417, final touch filtering unit 418, and fine-touch interpolation unit 419 are optimized for adaptive processing of the touch signals. That is, these components of the touch signal processing architecture 400 are optimized for dynamic tuning of touch sensitivity in order to detect touches from various different touch types (e.g., stylus, finger, palm, etc.) by time multiplexing one or more frames. By increasing the scan rate of the touch panel, the touch signal processing architecture 400 may tune the touch sensitivity in a first frame for detecting touches resulting in first touch primitive size and tune the touch sensitivity in a second frame for detecting touches resulting in a second touch primitive size.

FIG. 5 illustrates touch primitives (or touch blobs) within multiple frames captured by a touch interface. The particular example shows two frames (frame A 510 and frame B 520). The captured frames may represent images of the capacitive touch panel 170 (FIG. 1) that is part of a touch interface. The touch interface may be a part of, for example, the portable device. Both frame A and frame B show a finger touch primitive 206 and a stylus touch primitive 208. The finger touch primitive 206 may be the result of a user touching his/her finger to the touch panel. The stylus touch primitive 208 may be the result of a user touching a stylus to the touch panel. It can be appreciated that in the present context, a frame may refer to an entire scan of the touch panel grid.

It can be appreciated that the frames illustrated in FIG. 5 may be captured by the scanning engine 448 (FIG. 4). As described above, the touch signal processing architecture 400 (FIG. 4) may time multiplex the capturing of the frames such that a first frame may be dedicated for detecting a touch primitive having a first size range and a second frame may be dedicated for detecting a touch primitive having a second size range. As such, the touch signal processing architecture 400 (FIG. 4) may dynamically tune itself for detection of various different touch sizes on the touch panel. For each frame, the touch signal processing architecture 400 (FIG. 4) may set or adjust a touch-reporting sensitivity for the touch primitive (or touch blob). For example, the touch signal processing architecture 400 (FIG. 4) may set a first touch-reporting sensitivity for the touch primitives in frame A 510 and a second touch-reporting sensitivity for the touch primitives in frame B 520.

In one example, the first touch-reporting sensitivity can be set or adjusted for detecting stylus touches, e.g., touches with touch primitives less than 2 mm in diameter. In some embodiments, the touch signal processing architecture 400 (FIG. 4) may be able to detect the presence of an active stylus proximate to the touch panel. For example, the active stylus may emit a signal detectable by the touch signal processing architecture 400 (FIG. 4) that indicates the active stylus' proximity to the touch panel. In such a case, one or more frames may be dedicated to detect a stylus touch based on the proximity of the active stylus to the touch panel. In another example, the second touch-reporting sensitivity can be set or adjusted for detecting finger touches, e.g., touch primitives greater than 2 mm in diameter and less than 19 mm in diameter. It can be appreciated that the touch-reporting sensitivity for any frame captured by the scanning engine may be set or adjusted for any type of touch and that stylus touches and finger touches are merely examples.

Other properties of the touch interface may also be altered by the touch signal processing architecture 400 while dynamically tuning or adapting itself to detect various touch sizes. In some embodiments, the scan rate of the scan engine may be changed based on which type of touch the current captured frame is reserved to detect. For example, detection of large touches may have a low scan rate while detection of stylus touches may have a high scan rate. In some embodiments, the false-touch rejection range for the touch primitives may be altered based on which type of touch the current captured frame is reserved to detect. For example, frames reserved to detect large touches may have a false-touch rejection range of less than 19 mm in diameter. That is, any touch primitives captured in the frame less than 19 mm in diameter may be rejected as noise. In another example, frames reserved to detect stylus touches may have a false-touch rejection range of greater than 2 mm in diameter. That is, any touch primitives captured in the frame greater than 2 mm in diameter may be rejected as noise. In yet another example, frames reserved to detect finger touches may have a false-touch rejection range of greater than 2 mm and less than 19 mm in diameter. In some embodiments, the threshold of the final filtering may be changed based on which type of touch the current captured frame is reserved to detect. For example, frames reserved to detect large touches may have a HIGH final filtering threshold. In another example, frames reserved to detect stylus touches may have a LOW final filtering threshold. In yet another example, frames reserved to detect stylus touches may have an adaptive final filtering threshold. In some embodiments, the type of fine interpolation may be changed based on which type of touch the current captured frame is reserved to detect. For example, HIGH-order IIR interpolation may be performed on the touch primitives within frames reserved to detect large touches. In another example, LOW-order IIR interpolation may be performed on the touch primitives within frames reserved to detect stylus touches. In yet another example, motion-dependent IIR interpolation may be performed on the touch primitives within frames reserved to detect finger touches.

In the example frames shown in FIG. 5, frame A 510 is reserved to detect stylus touches and frame B 520 is reserved to detect finger touches. In frame A 510, both a finger touch primitive 206 and a stylus touch primitive 208 exist. Frame A 510 may be reserved to detect stylus touches upon the touch signal processing architecture 400 (FIG. 4) detecting a stylus in proximity of the touch panel, as described above. Further, the touch signal processing architecture 400 (FIG. 4) may adapt the following scheme for stylus touch detection: HIGH scan rate, HIGH sensitivity, false-touch rejection range greater than 2 mm in diameter, LOW threshold final filtering, and LOW order IIR fine interpolation. The touch signal processing architecture 400 (FIG. 4) may consider the stylus touch primitive 208 as a valid touch and may reject the finger touch primitive 206 as noise since it is above the 2 mm diameter rejection range. In frame B 520, both a finger touch primitive 206 and a stylus touch primitive 208 exist. Frame B 520 may be reserved to detect finger touches. The touch signal processing architecture 400 (FIG. 4) may adapt the following scheme for finger touch detection: motion & noise dependent scan rate, size-variation dependent sensitivity, false-touch rejection range less than 2 mm in diameter and greater than 19 mm in diameter, adaptive final filtering, and motion-dependent fine interpolation.

As can be seen, both frame A 510 and frame B 520 may be reserved for detecting different types of touches. In some embodiments, more than one consecutive frame may be reserved for detecting a particular type of touch. For example, frames 1 and 5 may be reserved for detecting a finger touch and frames 2-4 may be reserved for detecting a stylus touch. In some embodiments, a higher number of frames may be reserved for detecting touches resulting in smaller touch primitives (e.g., stylus touches). As illustrated by the examples described above, both a stylus and a user's fingers may be touching the touch panel of the touch interface. However, the touch signal processing architecture 400 (FIG. 4) may time multiplex the detection of the various touches by reserving frames for detection of a specific type of touch, using the methods described above. As a result, the touch signal processing architecture 400 (FIG. 4) can detect and process touches from various different types of touches as valid touches and the user may use these various different types of touches to interact with the portable device. It can be appreciated that in some embodiments, frame reservation may not be necessary for finger touches (described below).

FIG. 6 is a table 600 illustrating adaptation schemes for processing different types of touches. More specifically, the table 600 shows adaption schemes implemented by the touch signal processing architecture 400 (FIG. 4) based on three different touch-types 610: large touch 612 (e.g., palm touch), stylus touch 614, and finger touch 616. Each of the different touch-types 610 may have different touch primitive features 620 inherent to the touch-type 610. The touch signal processing architecture 400 (FIG. 4) may select a different adaptation scheme for each of the different touch-types 610. Additionally, the touch signal processing architecture 400 (FIG. 4) may change a selection mechanism 630 based on the touch-type 610. For example, the selection mechanism 630 may be changed to select touches larger than 19 mm in diameter for a large touch 612. In another example, the selection mechanism 630 may be changed to detection of a stylus in proximity to the touch panel and detection of the stylus down status on the touch panel for a stylus touch 614 touch-type 610. In yet another example, the selection mechanism 630 may remain at or be changed to a default mode for a finger touch 616 touch-type 610.

The particular adaptation scheme selected may include selection of the following attributes: frame reservation 640, scan-rate 650, capacitive touch mode 660, touch sensitivity 670, false-touch rejection range 680, final filtering mode 690, and fine interpolation mode 695. It can be appreciated that the adaptation scheme may also include further attributes not shown or described in FIG. 6.

For a large touch 612 (e.g., palm touch) touch-type 610 the touch signal processing architecture 400 may change the selection mechanism 630 to select any touch primitives with a diameter greater than 19 mm. The touch signal processing architecture 400 (FIG. 4) may also implement the following adaption scheme for a large touch 612 touch-type 610: frame reservation, LOW scan-rate, projected-capacitance, minimum sensitivity, false-touch rejection range for touch primitives smaller than 19 mm in diameter, high-threshold final filtering, and high-order IIR fine interpolation.

For a stylus touch 614 touch-type 610 the touch signal processing architecture 400 may change the selection mechanism 630 to detect proximity of a stylus to the touch panel and detect the stylus down on the touch panel. The touch signal processing architecture 400 (FIG. 4) may also implement the following adaption scheme for a stylus touch 614 touch-type 610: frame reservation, HIGH scan-rate, projected-capacitance, high sensitivity, false-touch rejection range for touch primitives greater than 2 mm in diameter, low-threshold final filtering, and low-order IIR fine interpolation.

For a finger touch 616 touch-type 610 the touch signal processing architecture 400 may keep or change the selection mechanism 630 to a predetermined default amount. The touch signal processing architecture 400 (FIG. 4) may also implement the following adaption scheme for a finger touch 616 touch-type 610: no frame reservation, motion & noise dependent scan-rate, projected-capacitance, size variant sensitivity, false-touch rejection range for touch primitives smaller than 2 mm and greater than 19 mm in diameter, adaptive final filtering, and motion-dependent IIR fine interpolation.

FIG. 7 is a flowchart illustrating a method 700 for touch-size dependent adaptive touch processing. The method 700 may be executed by the touch signal processing architecture 400 (FIG. 4). In block 702, a wake-up request is sent to a host device as a result of detecting a touch on the touch panel. The host device may exist on the portable device. In block 704, the scan mode for the touch interface is changed to a projected capacitive scan mode.

In block 705, a decision is made as to whether the touch primitive size of the detected touch is small. If the size of the touch primitive is determined to be small, a request to the scan manager is made to allot (reserve) frames for a small touch size and the touch-sensitivity is set to high (block 706). In block 708, the small touch primitive resulting from the small touch (e.g., from a stylus) is processed and decoded. The method then continues to block 710 (described below).

If the size of the touch primitive is determined to not be small, the method continues to block 709. In block 709, a decision is made as to whether the touch primitive size of the detected touch is large. If the size of the touch primitive is determined to be large, a request to the scan manager is made to allot (reserve) frames for a large touch size and the touch-sensitivity is set to minimum (block 710). In block 712, the large touch primitive resulting from the large touch (e.g., from a user's palm) is processed and decoded. If the size of the touch primitive is determined to not be large, the method continues to block 716.

In block 714, the palm region from the touch panel is excluded. That is, the touch primitive resulting from a touch of a user's palm is excluded from further processing and/or decoding. In block 716, a determination is made whether any valid touch exists. The touch may be nominal touch (e.g., a finger touch) that is not considered to be a small (stylus) touch or large (palm) touch. If a determination is made that a valid touch does not exist, the touch interface enters a standby mode and waits for a touch (block 717). If a determination is made that a valid touch exists, a request is made to the scan-manager to allow frames for a nominal (e.g., finger touch) touch-size (block 718). In block 720, the nominal touch primitive resulting from the nominal touch is processed and decoded. The method then returns to block 705.

FIG. 8 is a flowchart illustrating an exemplary method 800 for recognizing touch input for a touch panel. In block 810, the touch panel is scanned over a first frame and a second frame, wherein the first frame and the second frame include a touch panel blob resulting from a touch on the touch panel. For example, the touch panel may be a capacitive touch panel part of the portable device in FIG. 1. The touch may result from a user touch via, for example, a user's finger, a user's palm, or a stylus device. The scanning may be performed by a scanning engine.

In block 820, a first touch-reporting sensitivity is set for the first frame and a second touch-reporting sensitivity is set for the second frame. The first and second touch-reporting sensitivities may be different. The first touch-reporting sensitivity may be set to detect a first type touch and the second touch-reporting sensitivity may be set to detect a second type of touch. A scan rate of the touch panel may also be adjusted. The first touch-reporting sensitivity can include a false-touch rejection size of less than 19 mm in diameter. The second touch-reporting sensitivity can include a false-touch rejection size of greater than 2 mm in diameter.

In block 830, the touch panel blob within the first frame is processed based at least in part on the first touch-reporting sensitivity and the touch panel blob within the second frame is processed based at least in part on the second touch-reporting sensitivity. The first and second frames may be processed by adapting false-touch rejection ranges, adjusting final filtering types, adjusting fine interpolation types, and determining a touch coordinate.

In block 840, a determination is made whether a valid touch exists based at least in part on the processing step. A position of the touch blob relative to the touch panel may be determined based at least in part on the processing step.

In some embodiments, the method may continue by scanning the touch panel over a third frame that includes the touch panel blob resulting from the touch on the touch panel. A third-reporting sensitivity may be set for the third frame. The touch panel blob within the third frame may be processed based at least in part on the third touch-reporting sensitivity. A determination may be made whether a valid touch exists based at least in part on the processing step. In some embodiments, the third touch-reporting sensitivity includes setting a false-touch rejection size of less than 2 mm and greater than 19 mm in diameter.

### Exemplary Computing System

FIG. 9 illustrates an example of a computing system in which one or more embodiments may be implemented. A computer system as illustrated in FIG. 9 may be incorporated as part of the above described input recognition device. For example, computer system 900 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 9 provides a schematic illustration of one embodiment of a computer system 900 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 9 is meant only to provide a generalized illustration of various components, any or all of which may be utilized as appropriate. FIG. 9, therefore, broadly illustrates how individual system elements may be implemented in a relatively separated or relatively more integrated manner. In some embodiments, computer system 900 may be used to implement functionality of the capacitive touch panel in FIG. 1.

The computer system 900 is shown comprising hardware elements that can be electrically coupled via a bus 930 (or may otherwise be in communication, as appropriate). The hardware elements may include one or more processors 904, including without limitation one or more general-purpose processors and/or one or more special-purpose processors (such as digital signal processing chips, graphics acceleration processors, and/or the like); one or more input devices 908, which can include without limitation one or more cameras, sensors, a mouse, a keyboard, a microphone configured to detect ultrasound or other sounds, and/or the like; and one or more output devices 910, which can include without limitation a display unit such as the device used in embodiments of the invention, a printer and/or the like.

In some implementations of the embodiments of the invention, various input devices 908 and output devices 910 may be embedded into interfaces such as display devices, tables, floors, walls, and window screens. Furthermore, input devices 908 and output devices 910 coupled to the processors may form multi-dimensional tracking systems.

The computer system 900 may further include (and/or be in communication with) one or more non-transitory storage devices 906, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 900 might also include a communications subsystem 912, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 912 may permit data to be exchanged with a network, other computer systems, and/or any other devices described herein. In many embodiments, the computer system 900 will further comprise a non-transitory working memory 918, which can include a RAM or ROM device, as described above.

The computer system 900 also can comprise software elements, shown as being currently located within the working memory 918, including an operating system 914, device drivers, executable libraries, and/or other code, such as one or more application programs 916, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 906 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 900 may be omitted or may be implemented separate from the illustrated system. For example, the processor 904 and/or other elements may be implemented separate from the input device 908. In one embodiment, the processor is configured to receive images from one or more cameras that are separately implemented. In some embodiments, elements in addition to those illustrated in FIG. 9 may be included in the computer system 900.

Some embodiments may employ a computer system (such as the computer system 900) to perform methods in accordance with the disclosure. For example, some or all of the procedures of the described methods may be performed by the computer system 900 in response to processor 904 executing one or more sequences of one or more instructions (which might be incorporated into the operating system 914 and/or other code, such as an application program 916) contained in the working memory 918. Such instructions may be read into the working memory 918 from another computer-readable medium, such as one or more of the storage device(s) 906. Merely by way of example, execution of the sequences of instructions contained in the working memory 918 might cause the processor(s) 904 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 900, various computer-readable media might be involved in providing instructions/code to processor(s) 904 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 906. Volatile media include, without limitation, dynamic memory, such as the working memory 918. Transmission media include, without limitation, coaxial cables, copper wire and fiber optics, including the wires that comprise the bus 902, as well as the various components of the communications subsystem 912 (and/or the media by which the communications subsystem 912 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 904 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 912 (and/or components thereof) generally will receive the signals, and the bus 902 then might carry the signals (and/or the data, instructions, etc. carried by the signals) to the working memory 918, from which the processor(s) 904 retrieves and executes the instructions. The instructions received by the working memory 918 may optionally be stored on a non-transitory storage device 906 either before or after execution by the processor(s) 904.

### Additional Embodiments

FIG. 10 is a diagram illustrating an example of mobile device architecture 1200 with a touch screen display and an external display device. In this example, the mobile device architecture 1200 includes an application processor 1202, a cache 1204, an external memory 1206, a general-purpose graphics processing unit (GPGPU) 1208, an application data mover 1210, an on-chip memory 1212 that is coupled to the application data mover 1210 and the GPGPU 1208, and a multispectral multiview imaging core, correction/optimization/enhancement, multimedia processors and accelerators component 1214 that is coupled to the on-chip memory 1212. The application processor 1202 communicates with the cache 1204, the external memory 1206, the GPGPU 1208, the on-chip memory 1212, and the multispectral multiview imaging core, correction/optimization/enhancement, multimedia processors and accelerators component 1214. The mobile device architecture 1200 further includes an audio codec, microphones, headphone/earphone, and speaker component 1216, a display processor and controller component 1218, and a display/touch panels with drivers and controllers component 1220 coupled to the display processor and controller component 1218. The mobile architecture 1200 may optionally include an external interface bridge (e.g., a docking station) 1222 coupled to the display processor and controller component 1218, and an external display 1224 coupled to the external interface bridge 1222. The external display 1224 may be coupled to the external interface bridge 1222 via a wireless-display connection 1226 or a wired connection, such as a high-definition multimedia interface (HDMI) connection. The mobile device architecture 1200 further includes a connection processor 1228 coupled to a 3G/4G modem 1230, a Wi-Fi modem 1232, a Satellite Positioning System (SPS) sensor 1234, and a Bluetooth module 1236. The mobile device architecture 1200 also includes peripheral devices and interfaces 1238 that communicate with an external storage module 1240, the connection processor 1228, and the external memory 1206. The mobile device architecture also includes a security component 1242. The external memory 1206 is coupled to the GPGPU 1208, the application data mover 1210, the display processor and controller 1218, the audio codec, microphones, headphone/earphone and speaker component 1216, the connection processor 1228, the peripheral devices and interfaces 1238, and the security component 1242.

The mobile device architecture 1200 further includes a battery monitor and platform resource/power manager component 1244 that is coupled to a battery charging circuit and power manager component and to temperature compensated crystal oscillators (TCXOs), phase-lock loops (PLLs), and clock generators component 1446. The battery monitor and platform resource/power manager component 1244 is also coupled to the application processor 1202. The mobile device architecture 1200 further includes sensors and user-interface devices component 1248 coupled to the application processor 1202, and includes light emitters 1250 and image sensors 1252 coupled to the application processor 1202. The image sensors 1252 are also coupled to the multispectral multiview imaging core, correction/optimization/enhancement, multimedia processors and accelerators component 1214.

FIG. 11 is a diagram illustrating an example of a mobile touch screen device 1100 with a touch screen controller. The mobile touch screen device 1100 includes a touch screen display unit 1302 and a touch screen subsystem with a standalone touch screen controller 1304 that are coupled to a multi-core application-processor subsystem with High Level Output Specification (HLOS) 1306. The touch screen display unit 1302 includes a touch screen panel and interface unit 1308, a display driver and panel unit 1310, and a display interface 1312. The display interface 1312 is coupled to the display driver and panel 1310 and the multi-core application-processor subsystem with HLOS 1306. The touch screen panel and interface unit 1308 receives a touch input via a user touch, and the display driver and panel unit 1310 displays an image. The touch screen subsystem 1304 includes an analog front end 1314, a touch activity and status detection unit 1316, an interrupt generator 1318, a touch processor and decoder unit 1320, clocks and timing circuitry 1322, and a host interface 1324. The analog front end 1314 communicates with the touch screen panel and interface 1308 to receive an analog touch signal based on a user touch on the touch screen, and may convert the analog touch signal to a digital touch signal to create touch signal raw data. The analog front end 1314 may include row/column drivers and an analog-to-digital converter (ADC).

The touch activity and status detection unit 1316 receives the touch signal from the analog front end 1314 and then communicates to the interrupt generator 1318 of the presence of the user touch, such that the interrupt generator 1318 communicates a trigger signal to the touch processor and decoder unit 1320. When the touch processor and decoder unit 1320 receives the trigger signal from the interrupt generator 1318, the touch processor and decoder 1320 receives the touch signal raw data from the analog front end 1314 and processes the touch signal raw data to create touch data. The touch processor and decoder 1320 sends the touch data to the host interface 1324, and then the host interface 1324 forwards the touch data to the multi-core application processor subsystem 1306. The touch processor and decoder 1320 is also coupled to the clocks and timing circuitry 1322 that communicates with the analog front end 1314.

In some embodiments, processing of the touch signal raw data is processed in the subsystem 1306 instead of in the unit 1320. In some such embodiments, the control 1304 or more or more components thereof, for example the unit 1320, may be omitted. In other such embodiments, the controller 1304 and/or all components thereof are included, but touch signal raw data is passed through to the subsystem 1306 without or with reduced processing. In some embodiments, processing of the touch signal raw data is distributed between the unit 1320 and the subsystem 1306.

The mobile touch screen device 1100 also includes a display-processor and controller unit 1326 that sends information to the display interface 1312, and is coupled to the multi-core application processor subsystem 1306. The mobile touch screen device 1100 further includes an on-chip and external memory 1328, an application data mover 1330, a multimedia and graphics processing unit (GPU) 1332, and other sensor systems 1334, which are coupled to the multi-core application processor subsystem 1306. The on-chip and external memory 1328 is coupled to the display processor and controller unit 1326 and the application data mover 1330. The application data mover 1330 is also coupled to the multimedia and graphics processing unit 1332.

FIG. 12 illustrates an example of a capacitive touch processing data path in a touch screen device 1400. The touch screen device 1400 has a touch scan control unit 1402 that is coupled to drive control circuitry 1404, which receives a drive signal from a power management integrated circuit (PMIC) and touch-sense drive supply unit 1406. The drive control circuitry 1404 is coupled to a top electrode 1408. The capacitive touch screen includes two sets of electrodes, where the first set includes the top electrode 1408 (or an exciter/driver electrode) and the second set includes a bottom electrode 1410 (or a sensor electrode). The top electrode 1408 is coupled to the bottom electrode 1410 with capacitance between the top electrode 1408 and the bottom electrode 1410. The capacitance between the top electrode 1408 and the bottom electrode 1410 includes an electrode capacitance (celectrode) 1412, a mutual capacitance (cmutual) 1414, and a touch capacitance (ctouch) 1416. A user touch capacitance (CTOUCH) 1418 may form when there is a user touch on the top electrode 1408 of the touch screen. With the user touch on the top electrode 1408, the user touch capacitance 1418 induces capacitance on the top electrode 1408, thus creating a new discharge path for the top electrode 1408 through the user touch. For example, before a user's finger touches the top electrode 1408, the electrical charge available on the top electrode 1408 is routed to the bottom electrode 1410. A user touch on a touch screen creates a discharge path through the user touch, thus changing a discharge rate of the charge at the touch screen by introducing the user touch capacitance 1418. The user touch capacitance 1418 created by a user touch may be far greater than capacitances between the top electrode 1408 and the bottom electrode 1410 (e.g., the electrode capacitance 1412, the mutual capacitance 1414, and the touch capacitance 1416), and thus may preempt the other capacitances (e.g., celectrode 1412, cmutual 1414, and ctouch 1416) between the top electrode 1408 and the bottom electrode 1410.

The bottom electrode 1410 is coupled to charge control circuitry 1420. The charge control circuitry 1420 controls a touch signal received from the top and bottom electrodes 1408 and 1410, and sends the controlled signal to a touch conversion unit 1422, which converts the controlled signal to a proper signal for quantization. The touch conversion unit 1422 sends the converted signal to the touch quantization unit 1424 for quantization of the converted signal. The touch conversion unit 1422 and the touch quantization unit 1424 are also coupled to the touch scan control unit 1402. The touch quantization unit 1424 sends the quantized signal to a filtering/de-noising unit 1426. After filtering/de-noising of the quantized signal at the filtering/de-noising unit 1426, the filtering/de-noising unit 1426 sends the resulting signal to a sense compensation unit 1428 and a touch processor and decoder unit 1430. The sense compensation unit 1428 uses the signal from the filtering/de-noising unit 1426 to perform sense compensation and provide a sense compensation signal to the charge control circuitry 1420. In other words, the sense compensation unit 1428 is used to adjust the sensitivity of the touch sensing at the top and bottom electrodes 1408 and 1410 via the charge control circuitry 1420.

The touch processor and decoder unit 1430 communicates with clocks and timing circuitry 1438, which communicates with the touch screen control unit 1402. The touch processor and decoder unit 1430 includes a touch reference estimation, a baselining, and adaptation unit 1432 that receives the resulting signal from the filtering/de-noising unit 1426, a touch-event detection and segmentation unit 1434, and a touch coordinate and size calculation unit 1436. The touch reference estimation, baselining, and adaptation unit 1432 is coupled to the touch-event detection and segmentation unit 1434, which is coupled to the touch coordinate and size calculation unit 1436. The touch processor and decoder unit 1430 also communicates with a small co-processor/multi-core application processor 1440 with HLOS, which includes a touch primitive detection unit 1442, a touch primitive tracking unit 1444, and a symbol ID and gesture recognition unit 1446. The touch primitive detection unit 1442 receives a signal from the touch coordinate and size calculation unit 1436 to perform touch primitive detection, and then the touch primitive tracking unit 1444 coupled to the touch primitive detection unit 1442 performs the touch primitive tracking. The symbol ID and gesture recognition unit 1446 coupled to the touch primitive tracking unit 1444 performs recognition of a symbol ID and/or gesture.

Various touch sensing techniques are used in the touch screen technology. Touch capacitance sensing techniques may include e-field sensing, charge transfer, force-sensing resistor, relaxation oscillator, capacitance-to-digital conversion (CDC), a dual ramp, sigma-delta modulation, and successive approximation with single-slope ADC. The touch capacitance sensing techniques used in today's projected-capacitance (P-CAP) touch screen controller include a frequency-based touch-capacitance measurement, a time-based touch-capacitance measurement, and a voltage-based touch-capacitance measurement.

In the frequency-based measurement, a touch capacitor is used to create an RC oscillator, and then a time constant, a frequency, and/or a period are measured. The frequency-based measurement includes a first method using a relaxation oscillator, a second method using frequency modulation and a third method a synchronous demodulator. The first method using the relaxation oscillator uses a sensor capacitor as a timing element in an oscillator. In the second method using the frequency modulation, a capacitive sensing module uses a constant current source/sink to control an oscillator frequency. The third method using the synchronous demodulator measures a capacitor's AC impedance by exciting the capacitance with a sine-wave source and measuring a capacitor's current and voltage with a synchronous demodulator four-wire ratiometric coupled to the capacitor.

The time-based measurement measures charge/discharge time dependent on touch capacitance. The time-based measurement includes methods using resistor capacitor charge timing, charge transfer, and capacitor charge timing using a successive approximation register (SAR). The method using resistor capacitor charge timing measures sensor capacitor charge/discharge time for with a constant voltage. In the method using charge transfer, charging the sensor capacitor and integrating the charge over several cycles, ADC or comparison to a reference voltage, determines charge time. Many charge transfer techniques resemble sigma-delta ADC. In the method using capacitor charge timing using the SAR, varying the current through the sensor capacitor, matches a reference ramp.

The voltage-based measurement monitors a magnitude of a voltage to sense user touch. The voltage-based measurement includes methods using a charge time measuring unit, a charge voltage measuring unit, and a capacitance voltage divide. The method using the charge time measuring unit charges a touch capacitor with a constant current source, and measures the time to reach a voltage threshold. The method using the charge voltage measuring unit charges the capacitor from a constant current source for a known time and measures the voltage across the capacitor. The method using the charge voltage measuring unit requires a very low current, high-precision current source, and high-impedance input to measure the voltage. The method using the capacitance voltage divide uses a charge amplifier that converts the ratio of the sensor capacitor to a reference capacitor into a voltage (Capacitive-Voltage-Divide). The method using the capacitance voltage divide is the most common method for interfacing to precision low-capacitance sensors.

FIG. 13 illustrates a closer look at display and touch subsystems in mobile-handset architecture. The mobile handset 1500 includes a touch screen display unit 1502, a touch screen controller 1504, and a multi-core application processor subsystem with HLOS 1506. The touch screen display unit 1502 includes a touch panel module (TPM) unit 1508 coupled to the touch screen controller 1504, a display driver 1510, and a display panel 1512 that is coupled to the display driver 1510. The mobile handset 1500 also includes a system memory 1514, and further includes a user-applications and 2D/3D graphics/graphical effects (GFX) engines unit 1516, a multimedia video, camera/vision engines/processor unit 1518, and a downstream display scaler 1520 that are coupled to the system memory 1514. The user-applications and 2D/3D GFX engines unit 1516 communicates with a display overlay/compositor 1522, which communicates with a display-video analysis unit 1524. The display-video analysis unit 1524 communicates with a display-dependent optimization and refresh control unit 1526, which communicates with a display controller and interface unit 1528. The display controller and interface unit 1528 communicates with the display driver 1510. The multimedia video, camera/vision engines/processor unit 1518 communicates with a frame-rate-upconverter (FRU), de-interlace, scaling/rotation component 1530, which communicates with the display overlay/compositor 1522. The downstream display scaler 1520 communicates with a downstream display overlay/compositor 1532, which communicates with a downstream display processor/encoder unit 1534. The downstream display processor/encoder unit 1534 communicates with a wired/wireless display interface 1536. The multi-core application processor subsystem with HLOS 1506 communicates with the display-video analysis unit 1524, the display-dependent optimization and refresh control unit 1526, the display controller and interface unit 1528, the FRU, de-interlace, scaling/rotation component 1530, the downstream display overlay/compositor 1532, the downstream display processor/encoder unit 1534, and the wired/wireless display interface 1536. The mobile handset 1500 also includes a battery management system (BMS) and PMIC unit 1538 coupled to the display driver 1510, the touch-screen controller 1504, and the multi-core application processor subsystem with HLOS 1506.

There are known challenges for accurate sensing of touch in the touch screen. For example, a touch-capacitance can be small, depending on a touch-medium. The touch capacitance is sensed over high output impedance. Further, a touch transducer often operates in platforms with a large parasitic and noisy environment. In addition, touch transducer operation can be skewed with offsets and its dynamic range may be limited by a DC bias.

Several factors may affect touch screen signal quality. On the touch screen panel, the signal quality may be affected by a touch-sense type, resolution, a touch sensor size, fill factor, touch panel module integration configuration (e.g., out-cell, on-cell, in-cell, etc.), and a scan overhead. A type of a touch-medium such as a hand/finger or stylus and a size of touch as well as responsivity such as touch-sense efficiency and a transconductance gain may affect the signal quality. Further, sensitivity, linearity, dynamic range, and a saturation level may affect the signal quality. In addition, noises such as no-touch signal noise (e.g. thermal and substrate noise), a fixed-pattern noise (e.g., touch panel spatial non-uniformity), and a temporal noise (e.g., EMI/RFI, supply noise, display noise, use noise, use-environment noise) may affect the signal quality.

One approach commonly used to optimize a signal-to-noise ratio (SNR) of a touch signal is improving design robustness by minimizing stray capacitance, avoiding conductive overlays that span beyond a sensor panel, maximizing a sensor size and proximity to neighboring sensors, minimizing overlay thicknesses, and minimizing air-gaps in a TPM stackup. Another approach commonly used to optimize the SNR of the touch signal is baselining. The baselining approach considers TPM stackup specifications, use-environment characteristics, a platform context, and touch transducer and converter performance. The TPM stackup specification includes information on out-cell/on-cell/in-cell & display-type, touch screen controller (TSC) location (printed circuit board (PCB), flex, substrate, or glass), overlay non-uniformity, air-gap, and adhesive. The use-environment characteristics include contaminants, temperature, humidity, ambient-lighting. The platform context includes battery state-of-charge/state-of-voltage (SOC/SOV) and device kinetics (e.g., an accelerometer, a gyroscope). The state-of-charge may indicate how the battery is charging and may be used to estimate when the battery can reach a “FULL” status. The state-of-voltage may indicate the battery capacity (e.g., how much charge/battery-reserve the battery has), and may depend on a battery type. The touch transducer and converter performance includes sensitivity, saturation level, dynamic range, and linearity.

For at least the reasons discussed supra, an effective approach to achieve accurate touch sensing on the touch screen, for example to compensate for noise that may be introduced into a touch sensor or display, is desired. For example, estimation of a signal threshold level to reject unwanted noise and false touches may be beneficial in extracting valid touches. In noisy conditions, threshold determination becomes difficult and often leads to false touches.

Embodiments herein include robust adaptive methods to signal threshold determination is introduced here. These methods may adapt to signal levels in each frame of touch data. Further, signal threshold value may be reliably determined in noisy conditions. Such determination may be accomplished with fewer computational steps than in known methods and may be robust to noise, for example where other touch processing systems on smartphones are rendered useless. Such embodiments and/or threshold determinations and/or any other embodiments herein may be performed, for example, by one or more of the elements 1202, 1220, 1218, 1304, 1306, 1320, 1324, 1326, 1402, 1422, 1424, 1426, 1428, 1430, 1432, 1434, 1434, 1440, 1442, 1444, 1446, 1504, and/or 1506, and/or more or more components illustrated in FIGS. 12-15.

FIG. 14 is a flow chart of a method of signal threshold determination. The operations described in FIG. 14 may be performed by one or more of the elements 1202, 1220, 1218, 1304, 1306, 1320, 1324, 1326, 1402, 1422, 1424, 1426, 1428, 1430, 1432, 1434, 1434, 1440, 1442, 1444, 1446, 1504, and/or 1506, and/or more or more components illustrated in FIGS. 12-15, or any combination thereof.

From an image, such as a noise baselined image, min and max in the touch frame are determined (step 1610). Then, max−min is calculated (step 1620). Thereafter, one or more blob locations and/or a number of blob locations are determined (step 1630). In some embodiments, a connected components algorithm is used. In some embodiments, the connected components algorithm finds or determines regions of connected elements (e.g., pixels in the image) having the same or a similar value.

Further, peak location (X,Y) and associated value (V) in may be determined in each blob (step 1640). Additionally, the values (V1, V2 . . . VN) may be extracted and sorted, e.g., as (VS_{—}1, VS_{—}2, . . . VS_N) (step 1650). From this sorting, the difference between successive samples, e.g., (VS_{—}1-VS_{—}2, . . . VS_N−1-VS_N) maybe determined, and the peak and associated V may be determined (step 1660). The V may be set as the signal threshold for determining whether a touch has occurred.

FIG. 15 is a flow chart of a method of signal threshold determination. The operations described in FIG. 15 may be performed by one or more of the elements 1202, 1220, 1218, 1304, 1306, 1320, 1324, 1326, 1402, 1422, 1424, 1426, 1428, 1430, 1432, 1434, 1434, 1440, 1442, 1444, 1446, 1504, and/or 1506, and/or more or more components illustrated in FIGS. 12-15, or any combination thereof.

From an image, such as a noise baselined image, min and max in the touch frame are determined (step 1710). Then, max−min is calculated (step 1720). Thereafter, one or more blob locations and/or a number of blob locations are determined (step 1730). In some embodiments, a connected components algorithm is used. In some embodiments, the connected components algorithm finds or determines regions of connected elements (e.g., pixels in the image) having the same or a similar value.

Further, peak location and value in each blob may be determined (step 1740). The signal threshold may be initialized or otherwise set to be the peak value, and may be decremented while the number of blobs with values above the threshold value are monitored and/or calculated (step 1750). If there is an increase in blob numbers, the threshold value may be the previous threshold value (step 1760). Thus, the signal threshold may be set based on these operations.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 110—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method for recognizing touch input for a touch panel, comprising:
scanning the touch panel over a first frame including at least one touch panel blob resulting from a touch on the touch panel;
scanning the touch panel over a second frame including at least one touch panel blob resulting from a touch on the touch panel;
processing the touch panel blob within the first frame based at least in part on a first touch-reporting sensitivity and processing the touch panel blob within the second frame based at least in part on a second touch-reporting sensitivity; and
determining whether a valid touch exists based at least in part on the processing step.

2. The method of claim 1 further comprising:
scanning the touch panel over a third frame including at least one touch panel blob resulting from a touch on the touch panel;
processing the touch panel blob within the third frame based at least in part on a third touch-reporting sensitivity; and
determining whether a valid touch exists based at least in part on the processing step.

3. The method of claim 2 wherein processing the touch panel blob within the third frame comprises processing the touch panel blob with a false-touch rejection size of less than 2 millimeters and greater than 19 millimeters in diameter.

4. The method of claim 1 further comprising determining a position of the touch panel blob relative to the touch panel based at least in part on the processing step.

5. The method of claim 1 wherein the processing step further comprises adjusting a scan rate of the touch panel.

6. The method of claim 1 wherein the processing step further comprises filtering and interpolating the touch panel blob.

7. The method of claim 1 wherein processing the touch panel blob within the first frame comprises processing the touch panel blob with a false-touch rejection size of less than 19 millimeters in diameter.

8. The method of claim 1 wherein processing the touch panel blob within the second frame comprises processing the touch panel blob with a false-touch rejection size of greater than 2 millimeters in diameter.

9. An apparatus for recognizing touch input for a touch panel, comprising:
the touch panel;
a memory comprising touch positioning logic; and
a processor coupled to the touch panel and the memory, the processor operable, when the touch positioning logic is executed, to:
scan the touch panel over a first frame including at least one touch panel blob resulting from a touch on the touch panel;
scan the touch panel over a second frame including at least one touch panel blob resulting from a touch on the touch panel;
process the touch panel blob within the first frame based at least in part on a first touch-reporting sensitivity and processing the touch panel blob within the second frame based at least in part on a second touch-reporting sensitivity; and
determine whether a valid touch exists based at least in part on the processing step.

10. The apparatus of claim 9 wherein the processor is further operable, when the touch positioning logic is executed, to:
scan the touch panel over a third frame including at least one touch panel blob resulting from a touch on the touch panel;
process the touch panel blob within the third frame based at least in part on a third touch-reporting sensitivity; and
determine whether a valid touch exists based at least in part on the processing step.

11. The apparatus of claim 10 wherein processing the touch panel blob within the first frame comprises processing the touch panel blob with a false-touch rejection size of less than 2 millimeters and greater than 19 millimeters in diameter.

12. The apparatus of claim 9 wherein the processor is further operable, when the touch positioning logic is executed, to determine a position of the touch panel blob relative to the touch panel based at least in part on the processing step.

13. The apparatus of claim 9 wherein the processing step further comprises adjusting a scan rate of the touch panel.

14. The apparatus of claim 9 wherein the processing step further comprises filtering and interpolating the touch panel blob.

15. The apparatus of claim 9 wherein processing the touch panel blob within the first frame comprises processing the touch panel blob with a false-touch rejection size of less than 19 millimeters in diameter.

16. The apparatus of claim 9 wherein processing the touch panel blob within the second frame comprises processing the touch panel blob with a false-touch rejection size of greater than 2 millimeters in diameter.

17. An apparatus for recognizing touch input for a touch panel, comprising:
means for scanning the touch panel over a first frame including at least one touch panel blob resulting from a touch on the touch panel;
means for scanning the touch panel over a second frame including at least one touch panel blob resulting from a touch on the touch panel;
means for processing the touch panel blob within the first frame based at least in part on a first touch-reporting sensitivity and processing the touch panel blob within the second frame based at least in part on a second touch-reporting sensitivity; and
means for determining whether a valid touch exists based at least in part on the processing step.

18. The apparatus of claim 17 further comprising:
means for scanning the touch panel over a third frame including at least one touch panel blob resulting from a touch on the touch panel;
means for processing the touch panel blob within the third frame based at least in part on a third touch-reporting sensitivity; and
means for determining whether a valid touch exists based at least in part on the processing step.

19. The apparatus of claim 18 wherein processing the touch panel blob within the third frame comprises processing the touch panel blob with a false-touch rejection size of less than 2 millimeters and greater than 19 millimeters in diameter.

20. The apparatus of claim 17 further comprising means for determining a position of the touch panel blob relative to the touch panel based at least in part on the processing step.

21. The apparatus of claim 17 wherein the processing step further comprises adjusting a scan rate of the touch panel.

22. The apparatus of claim 17 wherein processing the touch panel blob within the first frame comprises processing the touch panel blob with a false-touch rejection size of less than 19 millimeters in diameter.

23. The apparatus of claim 17 wherein processing the touch panel blob within the second frame comprises processing the touch panel blob with a false-touch rejection size of greater than 2 millimeters in diameter.

24. A processor-readable non-transitory medium comprising processor readable instructions configured to cause a processor to:
scan a touch panel over a first frame including at least one touch panel blob resulting from a touch on the touch panel;
scan the touch panel over a second frame including at least one touch panel blob resulting from a touch on the touch panel;
process the touch panel blob within the first frame based at least in part on a first touch-reporting sensitivity and processing the touch panel blob within the second frame based at least in part on a second touch-reporting sensitivity; and
determine whether a valid touch exists based at least in part on the processing step.

25. The processor-readable non-transitory medium of claim 24 wherein the processor readable instructions are further configured to cause the processor to:
scan the touch panel over a third frame including at least one touch panel blob resulting from a touch on the touch panel;
process the touch panel blob within the third frame based at least in part on a third touch-reporting sensitivity; and
determine whether a valid touch exists based at least in part on the processing step.

26. The processor-readable non-transitory medium of claim 25 wherein processing the touch panel blob within the third frame comprises processing the touch panel blob with a false-touch rejection size of less than 2 millimeters and greater than 19 millimeters in diameter.

27. The processor-readable non-transitory medium of claim 24 wherein the processor readable instructions are further configured to cause the processor to determine a position of the touch panel blob relative to the touch panel based at least in part on the processing step.

28. The processor-readable non-transitory medium of claim 24 wherein the processing step further comprises adjusting a scan rate of the touch panel.

29. The processor-readable non-transitory medium of claim 24 wherein processing the touch panel blob within the first frame comprises processing the touch panel blob with a false-touch rejection size of less than 19 millimeters in diameter.

30. The processor-readable non-transitory medium of claim 24 wherein processing the touch panel blob within the second frame comprises processing the touch panel blob with a false-touch rejection size of greater than 2 millimeters in diameter.
